(19) United States
(12) Patent Application Publication
(10) Pub. No.: US 2021/0131586 A1
(43) Pub. Date: May 6, 2021

(54) Electric Valve Actuator with Energy Harvesting Position Detector Assemblies

(71) Applicant: Emerson Process Management Valve Automation, Inc., Houston, TX (US)

(72) Inventor: Magdalena S. Larsen, Mont Belview, TX (US)

(21) Appl. No.: 16/673,057

(22) Filed: Nov. 4, 2019

(51) Int. Cl. F16K 37/00; F16H 1/20; F16K 31/53

(52) U.S. Cl. CPC F16K 37/0033; F16K 37/0041; F16K 31/53; F16H 1/203

(57) ABSTRACT

An absolute valve position detector with self-powering capabilities is provided. An energy-harvesting position sensor is activated by the rotation of a pinion that rotates according to the opening and closing of the valve. The sensor outputs an electrical pulse that may be simultaneously used to provide power to the position detector and to indicate the rotation of the pinion and, therefore, the position of the valve. In a preferred example, the energy-harvesting sensor is activated by change in a magnetic field and the magnetic polarization of a Wiegand wire. In examples, the electrical pulse is induced in a coil wrapped around the Wiegand wire when a magnet disposed on the pinion is rotated.

### FIELD OF THE DISCLOSURE

The present disclosure relates generally to electric valve actuators, and more particularly, to energy-harvesting position detector assemblies that are operable in unstable power environments and without the use of an external power source.

### BACKGROUND OF THE DISCLOSURE

Control valves are commonly used in process control systems to control the flow of process fluids. A control valve typically includes a fluid flow control member (e.g., a valve plug) and a valve shaft that drives the fluid flow control member between an open position, permitting fluid flow therethrough, and a closed position, preventing fluid flow therethrough.

Actuators are commonly used to control operation of the control valve. Electric valve actuators, for example, employ a motor operatively coupled to the fluid flow control member via a drive system (e.g., one or more gears). During operation, when electric power is supplied to the motor, the electric actuator moves the fluid flow control member between the open position and the closed position via the drive system.

Some known electric valve actuators include an absolute position detector (APD) that tracks or determines the position of the fluid flow control member (and, more generally, the degree of openness of the control valve). In some cases, the APD may accomplish this by detecting the current position of a marker affixed to or associated with a moving component of the drive system, with the position of the marker representative of the degree of openness of the control valve. In other cases, the APD may accomplish this by determining the positional state of a series of interrelated moving components (e.g., gears) of the drive system via resolution of the combined current position of a series of markers on the interrelated moving components, with the positional state representative of the degree of openness of the control valve.

However, known electric valve actuators rely on external power sources and stable power conditions to operate the APD in order to maintain tracking of the position (i.e., degree of openness) of the control valve. Indeed, without an external power source, known electric valve actuators are unable to continue tracking the position of the control valve. Moreover, in unstable power environments, the APD must be constantly recalibrated to accurately track the position of the control valve. Batteries have been used to supply power to an APD in unstable power conditions, but this creates bulkier components, introduces potentially volatile materials to the system, and requires monitoring, maintenance, and replacement. Additionally, current electric valve actuators often require short stroke times due to limitations due to external batteries or power sources.

### SUMMARY

One aspect of the present disclosure includes a valve actuator for a valve. The valve actuator includes a drive element rotatable between a first position and a second position to open and close the valve, and a position detector assembly operatively coupled to the drive element to detect a position of the valve. The position detector assembly has a pinion configured to rotate in conjunction with rotation of the drive element, a magnet coupled to the pinion such that the magnet rotates as the pinion rotates, and an energy-harvesting sensor disposed adjacent to the magnet. The energy-harvesting sensor is configured to generate an electrical pulse responsive to rotation of the magnet. The electrical pulse is indicative of a change in position of the valve and is capable of powering circuitry that determines the position of the valve.

Another aspect of the present disclosure includes a position detector assembly for detecting a position of a valve. The position detector assembly includes a rotatable pinion adapted to rotate in conjunction with a change in the position of the valve, and a magnet coupled to the rotatable pinion, such that the magnet rotates as the rotatable pinion rotates. The position detector assembly further includes an energy-harvesting sensor disposed adjacent to the magnet. The energy-harvesting sensor has a wire coil and an electrical pulse is induced in the wire coil responsive to rotation of the magnet. The induced electrical pulse is indicative of the change in the position of the valve and is capable of powering circuitry that determines the position of the valve.

An additional aspect of the present disclosure includes a position detection system. The position detection system includes a rotatable pinion that is adapted to rotate in conjunction with a change in the position of a valve, a magnet coupled to the rotatable pinion, such that the magnet rotates as the rotatable pinion rotates, and position-tracking circuitry configured to calculate the position of the valve and store data indicative of the position of the valve. The position management circuitry is configured to power the position-tracking circuitry based on either an external power source or energy generated by the energy-harvesting sensor.

### BRIEF DESCRIPTION OF THE DRAWINGS

FIG. 1 is a plan view of one example of an electric valve actuator constructed in accordance with the teachings of the present disclosure.

FIG. 2 is a cutaway view of a portion of the electric valve actuator of FIG. 1.

FIG. 3 is similar to FIG. 2, but with additional components of the electric valve actuator removed for clarity.

FIG. 4 is a plan view of the electric valve actuator illustrated in FIG. 1, showing one example of an energy-harvesting absolute position detector assembly constructed in accordance with the teachings of the present disclosure.

FIG. 5 is a cutaway view illustrating further details of the energy-harvesting absolute position detector assembly of FIG. 4, including a marker and a Wiegand sensor.

FIG. 6 is a front, cutaway view of another example of an energy-harvesting absolute position detector assembly constructed in accordance with the teachings of the present disclosure, employing a plurality of magnets, Wiegand sensors, and digit gears.

FIG. 7 is a side, cutaway view of the absolute position detector assembly of FIG. 6.

FIG. 8 is an enlarged view of a selected portion of the absolute position detector assembly of FIG. 6.

FIG. 9 is a front, cutaway view of another example of an energy-harvesting absolute position detector constructed in accordance with the teachings of the present disclosure, employing a disk and multiple Wiegand sensors for increased spatial resolution.

FIG. 10 is a top, cutaway view of FIG. 9, including a set of diodes and converters configured to detect the direction of rotation of the disk.

FIG. 11 is a plot of electrical pulses provided to the converters shown in FIG. 10 responsive to clockwise and counter-clockwise rotations of the disk.

FIG. 12 is a block diagram of an example of an energy-harvesting absolute position detection system operatively coupled to a drive element of an actuator.

FIG. 13 is a block diagram of an example of the energy-harvesting absolute position detection system of FIG. 12, with a torque limit assembly operatively coupled to a drive element of an actuator.

### DETAILED DESCRIPTION

Disclosed herein are examples of electric valve actuators including an energy-harvesting absolute position detector (APD) assembly that is configured to monitor the position of the control valve operatively connected thereto with or without an external power source and under unstable power conditions. More particularly, the APD assembly includes a pinion and an energy-harvesting sensor that generates an electrical pulse in response to rotation of a magnet coupled to the pinion, which rotates responsive to rotation of a drive element that opens and closes the control valve. The generated electrical pulse may in turn be converted into a digital signal indicative of the current position (i.e., the degree of openness) of the control valve. Further, the electrical pulse is capable of powering circuitry of the APD assembly that determines the position of the control valve, for example, using the digital signal (which is based on the electrical pulse). In this way, the APD assembly can continue tracking the position of the control valve, with or without an external power source, and under unstable power conditions.

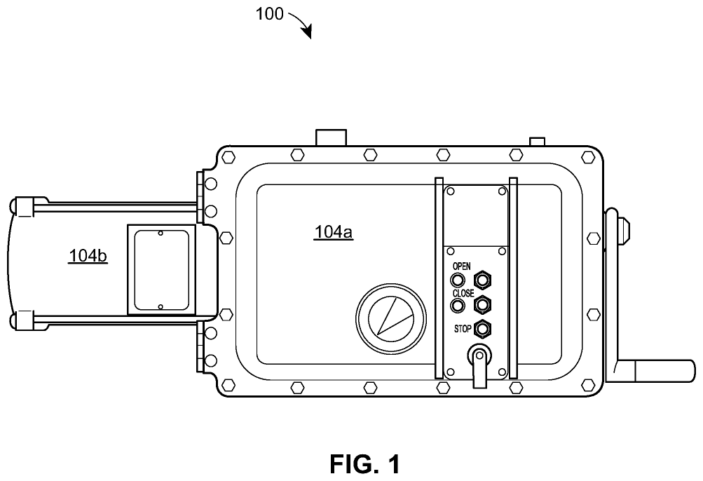

FIG. 1 illustrates one example of an electric valve actuator 100 constructed in accordance with the teachings of the present disclosure. While not illustrated herein, it will be appreciated that the electric valve actuator 100 can be part of, or otherwise used in connection with, a control valve, such as a sliding stem control valve. As is generally known, but not shown, the control valve has a fluid flow control member and a valve shaft that is connected to the fluid flow control member for moving the fluid flow control member between an open position, thereby opening the control valve and allowing fluid flow therethrough, and a closed position, thereby closing the control valve and preventing fluid flow therethrough.

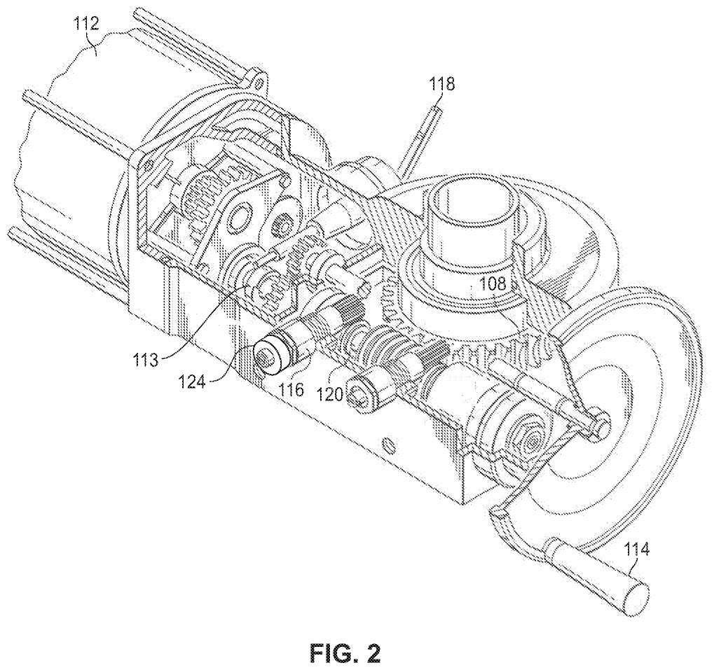

As illustrated in FIGS. 1 and 2, the electric valve actuator 100 in this example generally includes a central housing 104a, a motor housing 104b coupled to the central housing 104a, a drive element 108 disposed in the housing 104a, a motor 112 disposed in the motor housing 104b selectively operatively coupled to the drive element 108, a hand crank 114 selectively operatively coupled to the drive element 108, and a clutch 118 that enables switching of the electric valve actuator 100 between an automatic operation mode (in which the motor 112 is operatively coupled to and controls the drive element 108) and a manual operation mode (in which the hand crank 114 is operatively coupled to and controls the drive element 108). While not illustrated herein, the drive element 108 is operatively coupled to the fluid flow control member of the control valve, either via the valve shaft or another component coupled to the valve shaft, such that movement of the drive element 108 between a first position and a second position moves the fluid flow control member between the open position and the closed position to respectively open and close the control valve. In this example, the drive element 108 takes the form of a worm gear that is rotatable between a first position that corresponds to the open position of the fluid flow control member (and more generally the control valve) and a second position that corresponds to the closed position of the fluid flow control member (and more generally the control valve). In other examples, however, the drive element 108 may take the form of a different component (e.g., a component that moves linearly to move the fluid flow control member between the open and closed positions). In any case, the drive element 108 moves between the first position and the second position responsive to rotation caused by the motor 112 when the actuator 100 is in the automatic operation mode, or by the hand crank 114 when the actuator 100 is in the manual operation mode. When the actuator 100 is in the automatic operation mode, the motor 112 drives a drive shaft 113, which in turn drives the drive element 108, thereby moving the drive element 108 between the first position and the second position. Conversely, when the actuator 100 is in the manual operation mode, a user can manually drive the drive shaft 113 by rotating the hand crank 114, which in turn drives the drive element 108 between the first position and the second position.

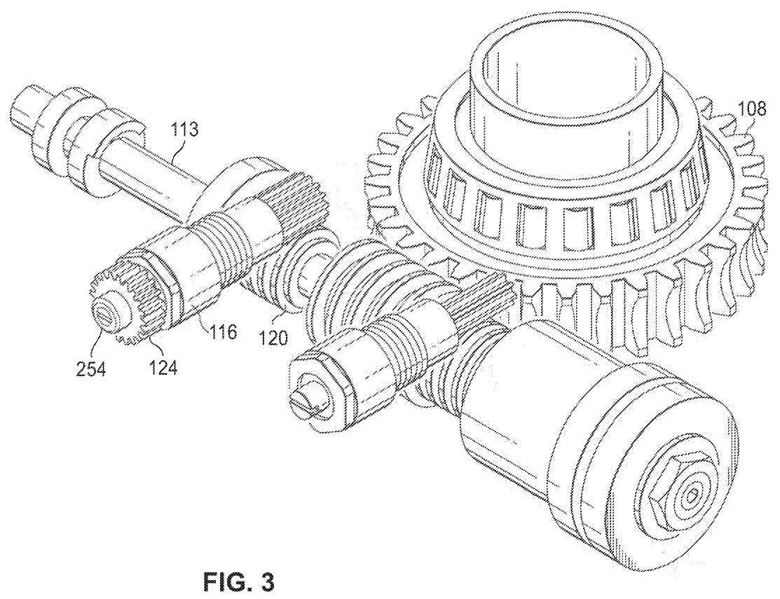

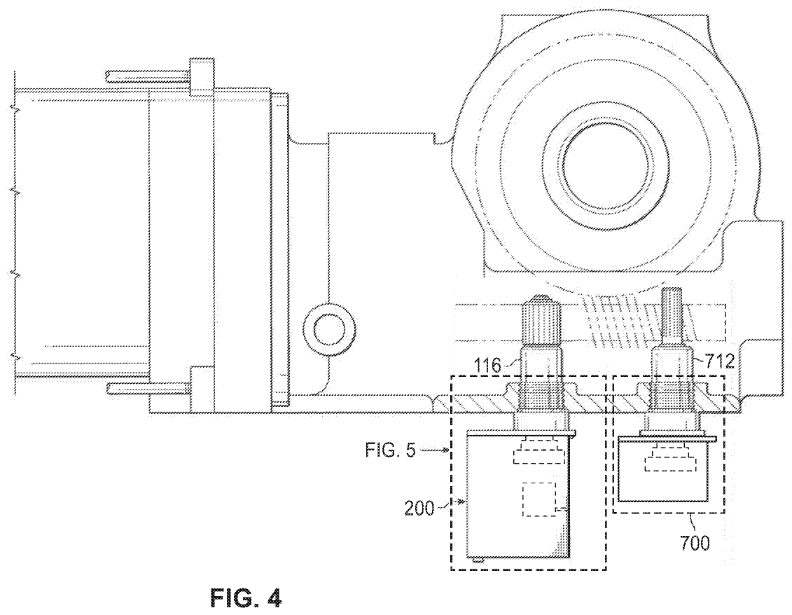

As illustrated in FIGS. 2-4, the electric valve actuator 100 in this example also includes an absolute position detector (APD) assembly 200 operatively coupled to the drive element 108 to detect a position of the control valve (i.e., to detect whether the control valve is open or closed). In this example, the APD assembly 200 includes a rotatable drive element in the form of a pinion 116 that is coupled to the drive element 108 via a helical gear 120 on the drive shaft 113, such that the pinion 116 is configured to rotate in conjunction with or otherwise responsive to rotation of the drive element 108, regardless of whether the drive element 108 is driven by the motor 112 in the automatic mode of operation or manually by the hand crank 114 in the manual mode of operation. In other examples, however, the ADP assembly 200 may be operatively coupled to the drive element 108 via one or more other components (e.g., a rotatable drive element other than the pinion 116).

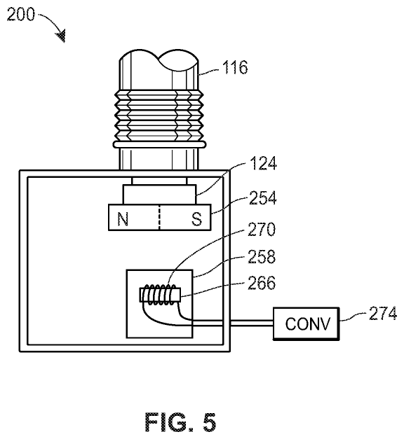

As illustrated in FIG. 5, the APD assembly 200 in this example further includes a marker 254 coupled to the pinion 116 and an energy-harvesting sensor 258 disposed adjacent the marker 254. The marker 254 in this example is coupled to and carried by an end 124 of the pinion 116. In other examples, however, the marker 254 can be coupled to a different portion of the pinion 116 or can be coupled to a gear or other component that is coupled to the pinion 116. In any case, the marker 254, which in this example takes the form of a magnet, is coupled to the pinion 116 such that the marker 254 rotates as the pinion 116 rotates (in conjunction with the drive element 108). The energy-harvesting sensor 258 is disposed adjacent the marker 254 such that the energy-harvesting sensor 258 is activated by rotation of the marker 254 due to rotation of the pinion 116 (and, thus, the drive element 108). The energy-harvesting sensor 258 generates an electrical pulse responsive to rotation of the marker 254, wherein the electrical pulse is indicative of a change in the position of the control valve and is capable of powering circuitry that determines the position of the control valve based on the electrical pulse.

More particularly, and as also illustrated in FIG. 5, the energy-harvesting sensor 258 in this example is a Wiegand sensor that has a Wiegand wire core 266 and a wire coil 270 wrapped around the Wiegand wire core 266. It will be appreciated that Wiegand wires, e.g., the Wiegand wire core 266 of FIG. 5, are generally segments of wire that can retain a magnetic field after an external magnetic field has been removed. Wiegand wires exhibit a very large magnetic hysteresis, which results in Wiegand wires having a high magnetic threshold whereupon the Wiegand wire rapidly switches magnetization polarity under exposure to a magnetic field having spatial components opposite that of the magnetic polarity of the Wiegand wire. Wiegand wires include an outside shell and an inner core, with the outside shell having a larger magnetic coercivity than the inside core. Once the magnetic threshold of the Weigand wire is reached, the inner core flips magnetic polarity due to the lower magnetic coercivity, and the outer shell then flips magnetic polarity following the magnetic polarity flip of the inner core. The Wiegand wire polarity switch of both the inner core and outer shell occurs on the order of microseconds, and the new polarity is then retained by the Wiegand wire. The polarity of the Wiegand wire's magnetization may be switched any number of times by application of the external magnetic field. Further, the switching of the Wiegand wire polarity may induce a current in nearby conductors, in nearby inductors, or an inductor or coil wrapped around the Wiegand wire.

Referring again to FIG. 5, the energy-harvesting sensor 258 (i.e., the Wiegand sensor) is disposed such that the Wiegand wire core 266 is exposed to a magnetic field generated by the marker 254. As the pinion 116 rotates, causing the marker 254 to rotate, magnetic field lines generated by the magnet 258 also rotate, causing some of the magnetic field lines across the Wiegand wire core 266 to have directional components that oppose the magnetic polarity of the Wiegand wire core 266. When the strength of the magnetic field lines across the Wiegand wire core 266 opposite the magnetic polarity reaches a magnetization threshold of the Wiegand wire core 266, the polarity of the Wiegand wire core 266 flips (on the order of microseconds). The Wiegand wire core 266 retains this new, flipped, polarity (which can be switched any number of times, as discussed above). Moreover, the change in magnetic polarity of the Wiegand wire core 266 induces an electrical pulse in the wire coil 270 wrapped around the Wiegand wire core 266. The induced electrical pulse is therefore indicative of a rotation of the pinion 116 (and, thus, the drive element 108) and may be further processed (e.g., with individual circuit elements, an integrated circuit, an analog to digital converter, a processor, or other electrical device) to determine the position of the control valve operatively coupled to the pinion 116 (via the drive element 108). For example, the APD assembly 200 may further include a converter 274 that is in electrical communication with the energy-harvesting sensor 258 and converts the electrical signal generated by the energy-harvesting sensor 258 into a digital signal indicative of the position of the control valve (or a change in the position of the control valve).

In some examples, energy from the electrical pulse generated by the energy-harvesting sensor 258 may also be harvested and used to power the converter 274 and/or other components. For example, the converter 274 may be a low power counter that is powered by the electrical pulse and converts the electrical pulse into a digital signal. The counter may track and store the number of rotations of the pinion 116 (which in turn relates to position of the control valve) based on the received electrical signals. Such an example enables the position of the control valve to be tracked in unstable energy environments, or when the electric valve actuator 100 is in manual mode (i.e., controlled by the hand crank 114). The energy-harvesting sensor 258 may be the sole energy source for the counter, or the counter may be locally or remotely powered by an external power source under normal operational conditions, and by the energy-harvesting sensor 258 under conditions involving loss of power to the counter, such as during power outages. As another example, the converter 274 may include a counter along with other components and the electrical pulse generated by the energy-harvesting sensor 258 may be harvested and used to power the counter and/or the other components. Additionally, energy-harvesting APD assemblies may also be implemented in devices deployed in a field or any location remote from power sources.

In some examples, the APD assembly 200 may include a battery in electrical communication with the energy-harvesting sensor 258, to store energy from the energy-harvesting sensor 258. The battery may power a counter, and/or other components of the APD assembly 200, under normal operational conditions, or may selectively power the counter, and/or other components of the APD assembly 200, only in the event of low power or a loss of power to the APD assembly 200. In this way, the counter continues tracking the position of the control valve in unstable power environments, thereby reducing downtime of the process control system utilizing the control valve, reducing potential maintenance and recalibration needs after a power loss, and increasing the reliability of the APD assembly 200 in unstable power environments.

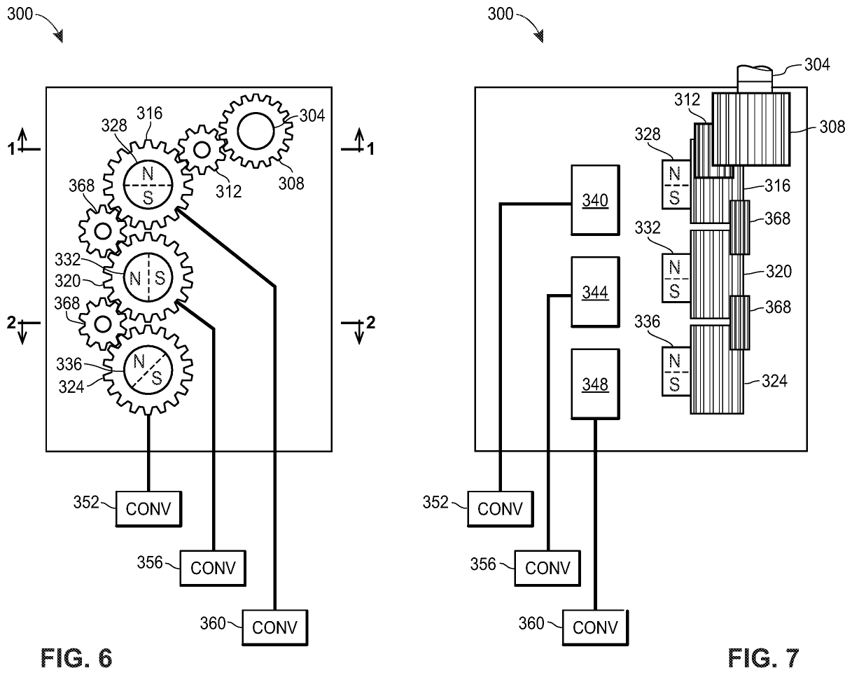

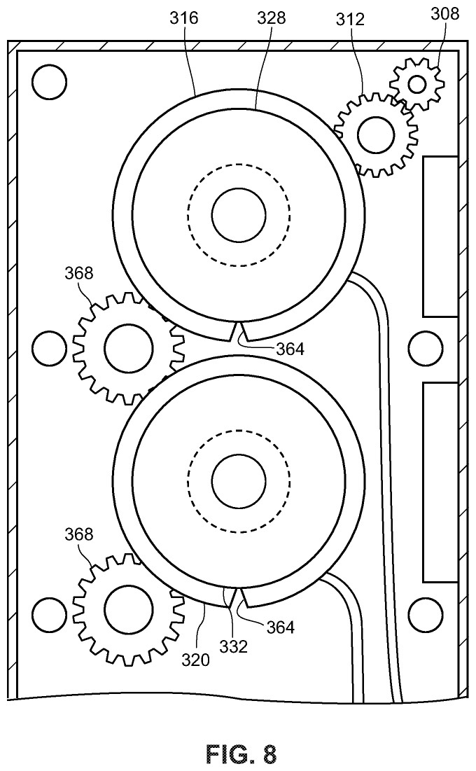

FIGS. 6-8 illustrate another example of an APD assembly 300 that is constructed in accordance with the teachings of the present disclosure and can be used instead of the APD assembly 200 to monitor the degree of openness of the control valve. As illustrated in FIGS. 7 and 8, the APD assembly 300 employs a plurality of magnets, energy-harvesting sensors (which in this example also take the form of Wiegand sensors), and digit gears, with each digit gear having a corresponding magnet and energy-harvesting sensor. Instead of the pinion 116, the APD assembly 300 includes a rotatable drive element 304 that is operatively coupled to the drive element 108 (e.g., via the drive shaft 113). The APD assembly 300 also includes an input gear 308 that is operatively coupled to and thus rotates according to the rotation of the drive element 304. The input gear 308 drives a first, lowest, digit gear 316 via a drive gear 312, which in turn drives a second digit gear 320 via a drive gear 368, which in turn drives a third, highest, digit gear 324 via a drive gear 368. The digit gears 316, 320, and 324 rotate independently, as is known in the art. Magnets 328, 332, and 336 are coupled to and carried by the digit gears 316, 320, and 324, respectively, and thus rotate with the digit gears 316, 320, and 324. Corresponding energy-harvesting position sensors 340, 344, and 348 (FIG. 8) are respectively disposed adjacent the magnets 328, 332, and 336 such that rotation of the magnets 328, 332, and 336 activate the energy-harvesting sensors 340, 344, and 348, respectively, causing the energy-harvesting sensors 340, 344, and 348 to generate electrical signals. The electrical signals may then be converted by converters 352, 356, and 360, respectively, in electrical communication with the energy-harvesting sensors 340, 344, and 348, respectively, into digital signals that each represent the position of the control valve. Alternatively, an electrical bus line may carry the collective electrical signals to one or more converters for conversion into digital signals that represent the position of the control valve.

It will be appreciated from FIGS. 6-8 that the digit gears 316, 320, and 324 increment in sequence, which thereby enables a more robust counting of multiple revolutions of the rotatable drive element 304. Indeed, as one digit gear (e.g., digit gear 316) completes all or part of a rotation, a tooth 364 or teeth thereon may advance an incrementing gear (e.g., incrementing gear 368), which in turn increments the next digit gear (i.e., the second digit gear 320 or third digit gear 324) in sequence by a predetermined rotation. A current relative positional state of the digit gears 316, 320, and 324 thus indicates the number of turns that the rotatable drive element 304 has made since a preselected datum (such as a predefined travel limit for the control valve). Similarly, more incremental gears may be implemented to increment any number of digit gears for tracking the rotations of the rotatable drive element 304 or other rotatable drive element.

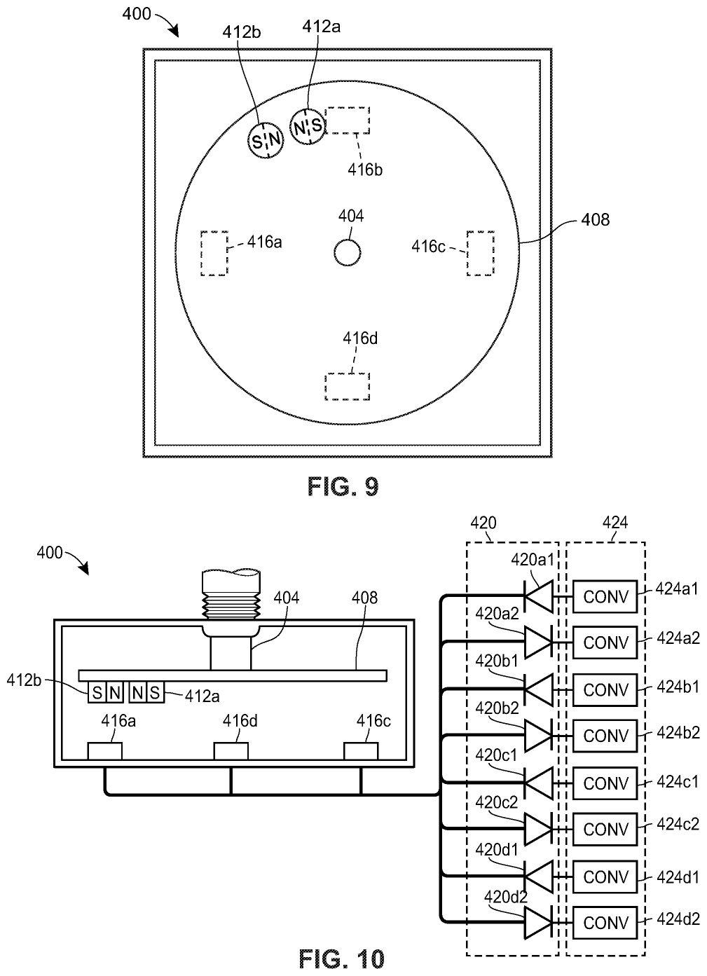

FIGS. 9 and 10 illustrate another example of an APD assembly 400 that is constructed in accordance with the teachings of the present disclosure and can be used instead of the APD assembly 200 to monitor the degree of openness of the control valve. Instead of including the pinion 116, the ADP assembly 400 includes a rotatable drive element 404 that is operatively coupled to (e.g., via the drive shaft 113) and thus rotates according to the rotation of the drive element 108. The APD assembly 400 of FIGS. 9 and 10 tracks rotation of the rotatable drive element 404 by employing a disk 408 coupled to the rotatable drive element 404, a first magnet 412a and a second magnet 412b each coupled to the disk 408, and a plurality of energy-harvesting sensors 416a-416d each taking the form of a Wiegand sensor. The Wiegand sensors 416a-416d are positioned adjacent to the disk 408, such that rotation of the rotatable drive element 404 rotates the disk 408, which causes the magnets 412a and 412b to travel along a trajectory that induces a polarization switch of Wiegand wire cores in each of the Wiegand sensors 416a-416d. Additionally, the magnets 412a and 412b are configured such that the same magnetic poles of the magnets 412a and 412b face each other. For example, the north magnetic pole of the magnet 412a faces the north magnetic pole of the magnet 412b, as illustrated in FIG. 10.

As the disk 408 rotates and the magnets 412a and 412b pass over the Wiegand sensors 416a-416d, the polarization switch of the Wiegand core in each of the Wiegand sensors 416a-416d induces a current in a wire coil wrapped around the respective Wiegand core, the current having a direction determined by the polarization switch according to Faraday's Law. Therefore, a current induced by a polarization switch due to magnet 412a will have an opposite sign, or direction, than a current induced by a polarization switch due to magnet 412b. Due to the directional nature of the polarization flip, diodes 420 (420a1-420d2) may be in electrical communication with the Wiegand sensors 416a-416d, with each sensor 416a-416d being electrically connected to two diodes, and converters 424 (424a1-424d2) may be in electrical communication with the diode set 420, respectively. For example, as illustrated in FIG. 10, a first Wiegand sensor 416a may be connected to first and second diodes 420a1 and 420a2, with the cathode of the first diode 420a1 in electrical communication with the first Wiegand sensor 416a, and the anode of the second diode 420a2 in electrical communication with the first Wiegand sensor 416a. First and second converters 424a1 and 424a2 may be in electrical communication with the first and second diodes 420a1 and 420a2, respectively, to receive a pulse from the first Wiegand sensor 416a. Such a configuration allows electrical current in one direction to be provided to the first converter 424a1, and electrical current in the opposite direction to be provided to the second converter 424a2. Therefore, clockwise rotation of the disk 408 may provide an electrical signal to the first converter 424a1 while not providing a significant electrical signal to the second converter 424a2, and counter-clockwise rotation of the disk 408 may provide an electrical signal to the second converter 424a2 while not providing a significant electrical signal to the first converter 424a1. Similarly, the diodes 420b1, 420b2, 420c1, 420c2, 420d1, and 420d2 may selectively provide a current, or electrical signal, from the Wiegand sensors 416b-416d to the converters 424b1, 424b2, 424c1, 424c2, 424d1, and 424d2, respectively. A processor (not shown) may further be in communication with the set of converters 424 to determine the rotational direction of the rotatable drive element 404, which is in turn indicative of active opening or closing of the control valve operatively coupled to the rotatable drive element 404, and a current position of the control valve.

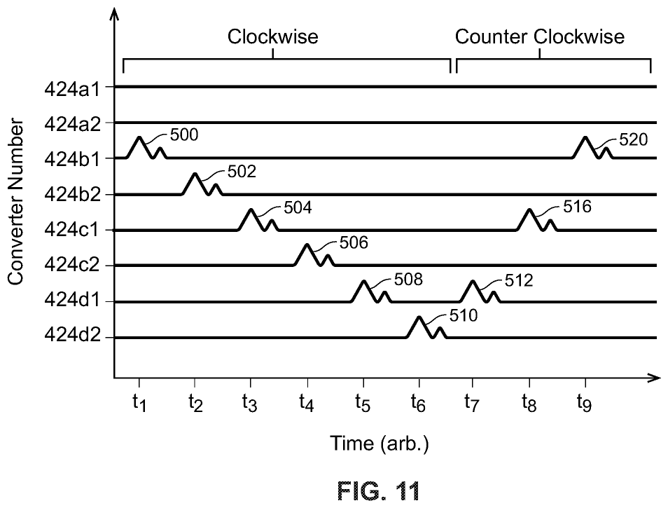

FIG. 11 is a plot of example electrical signals (e.g., an electrical current or voltage) provided to the converters 424 during rotation of the disk 408, with the disk 408 starting at the position illustrated in FIG. 9, and with the disk having already completed at least one clockwise rotation. The disk 408 rotates clockwise and the converter 424b2 receives a first electrical pulse 500 as the first magnet 412a passes the second Wiegand sensor 416b at a time t1. The converter 424b2 receives a second electrical pulse 502 as the second magnet 412b passes the second Wiegand sensor 416b at a time t2. Third and fourth electrical pulses 504 and 506 are then received by converters 424c1 and 424c2, respectively, as the first and second magnets 412a and 412b pass the third Wiegand sensor 416c, respectively, at times t₃ and t₄. The converters 424d1 and 424d2 then receive fifth and sixth electrical pulses 508 and 510 as the first and second magnets 412a and 212b pass the fourth Wiegand sensor at times t₅ and t₆. The disk 408 then stops rotating and reverses direction, sending a seventh electrical pulse 512 to converter 424d1 as the first magnet 412a passes the fourth Wiegand sensor 416d. Eighth and ninth electrical pulses 516 and 520 are received by converters 424c1 and 424b1, respectively, as the first magnet 412a passes over the third and second Wiegand sensors 412c and 412b, respectively, before the disk 408 returns to the initial position illustrated in FIG. 10. It should be noted that each of the pulses 500, 502, 504, 506, 508, 512, 516, and 520 illustrated in FIG. 11, have primary and secondary pulses with the primary pulse having an amplitude greater than, and occurring temporally before, the secondary pulse. The primary pulse of each of the pulses illustrated in FIG. 11 is due to the magnetic polarity switch of the Wiegand wire core, as previously discussed, and the secondary, lower amplitude pulse, is due to the magnetic polarization switch of the Wiegand wire outer shell. Additionally, while the example of FIG. 11 employs two different dipole magnets, other numbers of magnets or types of magnets may be used to perform similar functionalities described herein in reference to FIG. 11, one such example employs a multi-pole magnet ring instead of the first and second magnets 412a and 412b.

The energy-harvesting APD assembly 400 of FIGS. 9 and 10 employs two magnets 412a and 412b to determine the direction of rotation of the rotatable drive element 404, and therefore, to determine whether the control valve operatively coupled to the rotatable drive element 404, is opening or closing. In other examples, however, a single magnet or more than two magnets may be employed on the disk 408 and configured to induce electrical pulses in multiple Wiegand sensors in a manner similar to that described in connection with the example of FIGS. 9 and 10, to increase the resolution of position detection. In these other examples, the energy-harvesting ADP assembly 400 may alternatively employ one, two, three, or more than four Wiegand sensors to detect the position of the rotatable drive element 404 with a desired, or required, spatial resolution. Additionally, a single converter, without a diode, may be employed to determine the direction of rotation of the rotatable drive element 404, dependent upon the direction of current induced in a Wiegand sensor.

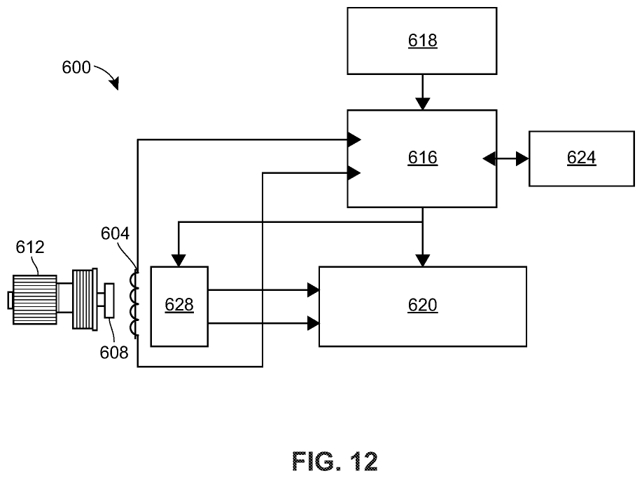

FIG. 12 is a block diagram of an example of an energy-harvesting APD system 600 that is constructed in accordance with the teachings of the present disclosure and can be operatively coupled to a drive element of an electric valve actuator (e.g., the electric valve actuator 100). The system 600 may monitor the position of the control valve with or without an external power source and under stable or unstable power conditions. The system 600 includes a Wiegand wire sensor 604 and a magnet 608. The magnet 608 is physically coupled to a limit drive pinion 612 and rotation of the limit drive pinion 612 results in rotation of the multipole magnet 608. The Wiegand wire sensor 604 is positioned such that it generates an electrical pulse in response to the rotation of the magnet 608. The Wiegand wire sensor 604 is in electrical communication with a power manager 616 and provides the electrical pulse to the power manager 616. During different operating conditions (e.g., stable power conditions, unstable power conditions, loss of power, etc.) the power manager 616 provides power, in the form of the electrical pulse from the Wiegand wire sensor 604, or power from another power source such as an external power source 618, a battery, or a super capacitor 624, to a microprocessor 620. In some examples, under normal power conditions, the external power source 618 may power the system 600 and a motor that controls the electric valve actuator (e.g., the motor 112 of FIG. 2 during automatic operation mode). Under unstable or low-power conditions, a hand crank, such as the hand crank 114 of FIG. 2 during manual operation mode, may allow a user to manually control the electric valve actuator. During the manual operation mode, the power manager 616 may provide the microprocessor 620 with power in the form of the electrical pulses generated by the Wiegand wire sensor 604, therefore maintaining position tracking during low-power or loss-of power conditions.

The microprocessor 620 may also include an analog-to-digital converter (ADC) configured to receive the electrical pulse from the Wiegand wire sensor 604 and convert the electrical pulse into a digital signal indicative of a change in the position of a valve operatively coupled to the limit drive pinion 612. The microprocessor 620 may further include ferromagnetic memory for storing data. The microprocessor 620 may include a serial peripheral interface (SPI) communicatively coupled with a central control module, an external network, and/or other electronic devices for communication with other hardware and/or devices. The ferromagnetic memory may store data associated with multiple digital signals indicative of changes in position of the valve, and the microprocessor 620 may determine a position of the valve based on the multiple digital signals.

The system 600 may include the super capacitor 624 for storing energy or power (i.e., to act as a supercapacitor battery), and to selectively provide power to the microprocessor 616. In examples, the power manager 616 may charge the super-capacitor 624 by selectively providing power to the super capacitor 624 from the external power source 618 or the Wiegand wire sensor 604. The super capacitor 624 may store energy associated with the power provided by the power manager 616. In certain conditions, such as in low power conditions or unstable power conditions, the power manager 616 may relay power from (i.e., channel power from) the super capacitor 624 to the microprocessor 620. As such, in low power or unstable power conditions, the power stored in the super capacitor 624 may power the microprocessor 620 and allow for the continued tracking and monitoring of the position of the valve operatively coupled to the limit drive pinion 612. The super capacitor 624 may store energy from the Wiegand wire sensor 604 and in unstable or low power conditions the super capacitor 624 may provide a constant supply of power to the microprocessor 616. In examples, such as in low power or unstable power conditions, the power manager 616 may relay the electrical signal from the Wiegand wire sensor 604 to the microprocessor 620 to simultaneously power the microprocessor 616 and to act as a signal indicative of rotation of the limit drive pinion 612.

In examples, the system 600 may further include a magnetic position sensor 628. The magnetic position sensor 628 may, for example, take the form of a Hall effect sensor for detecting the position of the magnet 608, because in some cases the Hall effect sensor may provide a more accurate signal indicative of the position of the magnet 608 than is provided by the pulses generated by the Wiegand wire sensor 604. In some examples, the Hall effect sensor of the magnetic position sensor 628 may provide signals indicative of the rotation and position of the limit drive pinion 612 to the microprocessor 616, and the pulses from the Wiegand wire sensor 604 may be used to power either the microprocessor 616 and/or the magnetic position sensor 628. In examples that employ both the Wiegand wire sensor 604 and the Hall effect sensor 628, rotation of the magnet 608 may cause the Wiegand wire sensor 604 to produce electrical pulses that are simultaneously used as an indicator of rotation of the limit drive pinion 612 and used to power the microprocessor 620 and/or the magnetic position sensor 628. Additionally, the pulses from the Wiegand wire sensor 604 may be counted by the microprocessor 620 and stored in a memory as a coarse resolution measurement of rotation of or position of the limit drive pinion 612, while the signal from the Hall effect sensor of the magnetic position sensor 628 is used as a fine resolution measurement of rotation of or position of the limit drive pinion 612, and openness of a control valve operatively coupled to the limit drive pinion 612.

In embodiments, the system 600 may further include a joint test action group (JTAG) for printed circuit board (PCB) operational verification, another industry standard verification element, resistors, capacitors, inductors, diodes, and other circuit elements for electrical rectification, analog-to-digital conversion, digital-to-analog conversion, signal or pulse filtering, switching, multiplexing, demultiplexing, energy storage, and/or other functionalities.

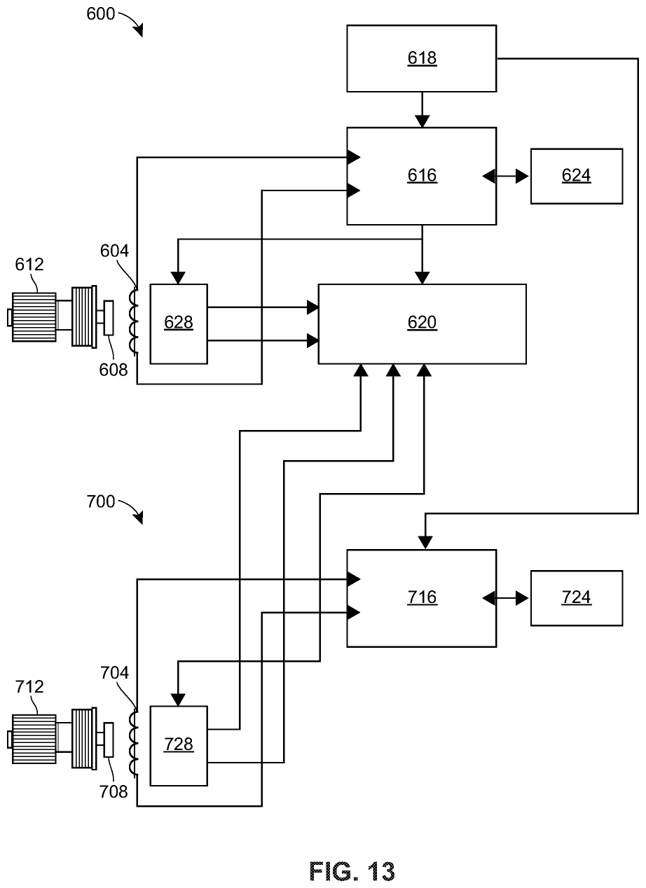

In examples, Wiegand sensors may also be implemented in a torque sensor apparatus. FIG. 13 is a block diagram of one such example, including the APD assembly 600 and a torque limit assembly 700 that is constructed in accordance with the teachings of the present disclosure and can be operatively coupled to a drive element of an electric valve actuator (e.g., the electric valve actuator 100). The torque limit assembly 700 may include a Wiegand wire sensor 704, a multipole magnet 708 coupled to (e.g., carried by) a torque drive pinion 712, and associated circuitry. The torque may be measured by counting the pulses generated by the Wiegand wire sensor 704 due to rotation of the multipole magnet 708. The torque limit assembly 700 may further include a Hall effect sensor 728 that may provide a signal indicative of the rotation or position of the magnet 708, and further indicative of the torque. The torque limit assembly 700 may include a torque assembly power manager 716 that can selectively provide power to the Hall effect sensor 728 and associated circuitry. The torque assembly power manager 716 may provide power in the form of the pulses generated by the Wiegand wire sensor 704 to the Hall effect sensor 728 to power the Hall effect sensor 728 that measures the torque. Similar to the system 600 of FIG. 12, the torque limit assembly 700 may include a super capacitor 724 for the storage of energy, and to selectively power the Hall effect sensor 728 used to measure the torque. In normal, stable power conditions, the torque assembly power manager 716 may provide power to the Hall effect sensor 728 from the external power source 618, with the external power source 618 also providing power to the system 600 and a motor (e.g., the motor 112). In examples, the torque limit assembly may provide the signal from the Hall effect sensor to a dedicated processor for tracking the torque, or, as illustrated in FIG. 13, the torque limit assembly 700 may provide the signal from the Hall effect sensor 728 to the microprocessor 620, with the microprocessor 620 simultaneously tracking the rotation/position of the limit drive pinion 612, and the torque drive pinion 712.

During full rotation of torque drive pinion 712, the microprocessor 620 may identify full open and full close limits. For example, a full open or close limit may be determined by a number of signal pulses received at the microprocessor 620 from the magnetic position sensor 628, from the Hall effect sensor 728, or from the Wiegand wire sensor 604. The full open and full close limits indicating when the electric valve actuator 100 has completely opened or completely closed a valve, which may eliminate the need for certain mechanical components such as torque springs and torque switches.

Of course, it will be understood that the foregoing circuitry and component details on FIG. 12 are illustrative only, and that energy-harvesting APDs described herein are not limited to any specific design or functionality of the described electronic circuitry. It will be further understood that energy-harvesting APDs described herein are not limited to the use of Wiegand sensor devices as a position-monitoring device. Moreover, where Wiegand effect devices are used to monitor magnetic flux or a change in the polarity of a magnetic field, the present energy-harvesting APD invention is in no way limited to the particular Wiegand effect device models used in the examples described. People of ordinary skill in the art will be able to select different devices with known performance characteristics, and then deploy the devices individually, in a chosen spatially arranged array, or as a combination of arrays to suit a specific application of the energy-harvesting APD invention.

The converter, described in examples herein, may be deployed in hardware, as illustrated in FIG. 12. In examples, the hardware is advantageously configured to receive a pulse from energy-harvesting position APDs. The converter may be any of many commercially available forms of hardware circuitry, such as logic integrated circuits, a programmable gate array (PGA), a field programmable gate array (FPGA), a programmable logic array (PLA), a programmable logic device (PLD), an erasable programming logic device (EPLD), an application specific integrated circuit (ASIC), an analog to digital converter, a digital counter or other such similar devices.

It should be appreciated that each of the magnets described herein may be a permanent magnet, a temporary magnet, an electromagnet, a ceramic magnet, a metallic magnet, a ferrite magnet, a rare earth magnet, a neodymium magnet, or an alnico magnet among other types of magnets. Additionally or alternatively, each of the magnets described herein may be a disk magnet, a donut magnet, a ring magnet, a marble magnet, a bar magnet, a pot magnet, a flexible magnet, or a horseshoe magnet among other magnet geometries.

It should also be appreciated that while in the examples described herein, one or more magnets are rotated to change the magnetic field across a Wiegand sensor, in other examples, the Wiegand sensor may be rotated or translated though regions with varying magnetic field poles to activate the Wiegand sensor. For example, with reference to FIG. 5, the position of the magnet 254 and the Wiegand sensor 258 may be switched, such that the Wiegand sensor 258 is instead coupled to the rotatable drive element 262. Further, electrical connections to the Wiegand sensor 258 may be established by wires with appropriate lengths to allow free rotation of the Wiegand sensor 258, by sliding electrical contacts, or by other methods.

Additionally, while the energy-harvesting APD assemblies described herein are used to monitor the position of a control valve by deploying magnets on rotatable elements that rotate in a circular loop, therefore activating energy-harvesting APDs, it will be appreciated that in other examples, the energy-harvesting APD assemblies may deploy magnets on elements having non-circular movement paths. Further, while the energy-harvesting APD assemblies described herein utilize magnets that travel on closed paths, in other examples, energy-harvesting assemblies may deploy magnets that travel on open paths. It will be appreciated that such travel will often reciprocate along the open paths, although such reciprocation is not required.

Finally, although certain APD assemblies have been described herein in accordance with the teachings of the present disclosure, the scope of coverage of this patent is not limited thereto. On the contrary, while the disclosed APD assemblies have been shown and described in connection with various examples, it is apparent that certain changes and modifications, in addition to those mentioned above, may be made. This patent application covers all examples of the teachings of the disclosure that fairly fall within the scope of permissible equivalents. Accordingly, it is the intention to protect all variations and modifications that may occur to one of ordinary skill in the art.

What is claimed:

1. A valve actuator for a valve, comprising:
a drive element rotatable between a first position and a second position to open and close the valve;
a position detector assembly operatively coupled to the drive element to detect a position of the valve, the position detector assembly comprising:
a pinion configured to rotate in conjunction with rotation of the drive element;
a magnet coupled to the pinion such that the magnet rotates as the pinion rotates; and
an energy-harvesting sensor disposed adjacent to the magnet, wherein the energy-harvesting sensor generates an electrical pulse responsive to rotation of the magnet, wherein the electrical pulse is indicative of a change in position of the valve and is capable of powering circuitry that determines the position of the valve.

2. The valve actuator of claim 1, wherein the electrical pulse is capable of powering circuitry that determines the position of the valve based on the electrical pulse.

3. The valve actuator of claim 1, wherein the position detector assembly further comprises a Hall effect sensor disposed adjacent to the magnet, wherein the electrical pulse is capable of powering circuitry that determines the position of the valve based on an electrical signal from the Hall effect sensor.

4. The valve actuator of claim 1, wherein the magnet has a magnetic polarity, and wherein the energy-harvesting sensor generates the electrical pulse responsive to a change in the magnetic polarity of a magnetic field caused by rotation of the magnet.

5. The valve actuator of claim 1, wherein the drive element comprises a worm drive gear.

6. The valve actuator of claim 1, wherein the energy-harvesting sensor comprises a Wiegand wire core and a wire coil wrapped around the Wiegand wire core, wherein the Wiegand wire core has a magnetic field having a magnetic polarity that changes responsive to rotation of the magnet, and wherein the electrical pulse comprises a current induced in the wire coil responsive to the change in the magnetic polarity of the magnetic field.

7. The valve actuator of claim 1, further comprising a converter powered by the electrical pulse, the converter configured to receive the electrical pulse from the energy-harvesting sensor, and the converter configured to convert the electrical pulse into a digital signal indicative of the position of the valve.

8. The valve actuator of claim 1, further comprising a motor operably coupled to the drive element to rotate the drive element between the first position and the second position.

9. A position detector assembly for detecting a position of a valve, comprising:
a rotatable pinion adapted to rotate in conjunction with a change in the position of the valve;
a magnet coupled to the rotatable pinion, such that the magnet rotates as the rotatable pinion rotates; and
an energy-harvesting sensor disposed adjacent to the magnet, the energy-harvesting sensor comprising a wire coil, wherein an electrical pulse is induced in the wire coil responsive to rotation of the magnet, and wherein the electrical pulse is indicative of the change in the position of the valve and is capable of powering circuitry that determines the position of the valve.

10. The position detector assembly of claim 9, wherein the electrical pulse indicative of the change in position of the valve is capable of powering circuitry that determines the position of the valve based on the electrical pulse.

11. The position detector assembly of claim 9, further comprising a Hall effect sensor disposed adjacent to the magnet, wherein the electrical pulse indicative of the change in position of the valve is capable of powering circuitry that determines the position of the valve based on an electrical signal from the Hall effect sensor.

12. The position detector assembly of claim 9, wherein the energy-harvesting sensor further comprises a Wiegand wire core, the wire coil wrapped around the Wiegand wire core, wherein the Wiegand wire core has a magnetic field having a magnetic polarity that changes responsive to rotation of the magnet, and wherein the electrical pulse comprises a current induced in the wire coil responsive to the change in the magnetic polarity of the magnetic field.

13. The position detector assembly of claim 9, further comprising a converter configured to receive the electrical pulse from the energy-harvesting sensor, the converter further configured to convert the electrical pulse into a digital signal indicative of a current position of the valve.

14. The position detector assembly of claim 13, wherein the electrical pulse is capable of powering the converter.

15. The position detector assembly of claim 9, further comprising a battery in electrical communication with the energy-harvesting sensor and configured to receive the electrical pulse and store a voltage associated with the electrical pulse.

16. The position detector assembly of claim 15, further comprising a converter, wherein the battery is further configured to be in electrical communication with the converter to selectively provide a voltage to the converter to power the converter.

17. The position detector assembly of claim 15, further comprising a power manager in electrical communication with the battery and configured to control when the battery provides a voltage to the converter.

18. The position detector assembly of claim 15, wherein the battery comprises a supercapacitor.

19. A position detection system, comprising:
a rotatable pinion that is adapted to rotate in conjunction with a change in the position of a valve;
a magnet coupled to the rotatable pinion, such that the magnet rotates as the rotatable pinion rotates;
an energy-harvesting sensor that generates an electrical pulse responsive to rotation of the magnet;
position-tracking circuitry that is configured to calculate the position of the valve and store data indicative of the position of the valve; and
power management circuitry that is configured to power the position-tracking circuitry based on either an external power source or energy generated by the energy-harvesting sensor.

20. The position detection system of claim 19, further comprising a Hall effect sensor disposed adjacent the magnet, wherein the position tracking circuitry calculates the position of the valve based on an electrical signal from the Hall effect sensor.

21. The position detection system of claim 19, further comprising a converter, the converter being configured to convert the electrical pulse generated by the energy harvesting sensor into a digital signal indicative of the change in the position of the valve.

22. The position detection system of claim 21, wherein the electrical pulse is capable of powering the converter.

23. The position detection system of claim 19, further comprising a memory, the memory being in electrical communication with the converter for storage of digital information indicative of the position of the valve.
